(19) United States
(12) Patent Application Publication
(10) Pub. No.: US 2014/0249936 A1
(43) Pub. Date: Sep. 4, 2014

(54) METHOD AND APPARATUS FOR PROCESSING CONTENT OFFERS IN A DIGITAL LOCKER SYSTEM

(71) Applicant: THOMSON LICENSING, Issy de Moulineaux (FR)

(72) Inventors: Stelian Markov, La Crescenta, CA (US); Praneeth Kongara, Los Angeles, CA (US); Warren Robert Vollinger, Studio City, CA (US); Samir M. Ahmed, Culver City, CA (US)

(73) Assignee: THOMSON LICENSING, Issy de Moutineaux (FR)

(21) Appl. No.: 14/349,100

(22) PCT Filed: Oct. 3, 2012
(86) PCT No.: PCT/US12/00463

§ 371 Date: Apr. 2, 2014

Related U.S. Application Data
(60) Provisional application No. 61/542,770, filed on Oct. 3, 2011.

(51) Int. Cl. G06Q 30/02

(52) U.S. Cl. CPC G06Q 30/0277
USPC 705/14.73

(57) ABSTRACT

A method and a digital locker system for providing digital locker services are described. Content offers come from external sources and locally hosted sources. Content offers from external sources are received and processed in a content offer processor along with catalog information. Content offers from locally hosted sources are retrieved and catalog information is generated accordingly. Both types of content offers are aggregated and prepared for storage in a content offer cache, which are then used for providing services, such as content query, to users. Content acquisition and playback requests from users are handled according to the provider of the requested content.

### CROSS-REFERENCE TO RELATED APPLICATIONS

The present application for patent claims the benefit of priority from U.S. Provisional Patent Application Ser. No. 61/542,770, entitled “Digital Locker Architecture,” and filed on Oct. 3, 2011. The teachings of the above-identified provisional patent application are expressly incorporated herein by reference.

### TECHNICAL FIELD

The present invention generally relates to digital locker systems. More particularly, it relates to processing content offers in a digital locker system for providing digital locker services to users.

### BACKGROUND OF THE INVENTION

Nowadays, digital contents, such as Video-on-Demand (VOD), TV program, music etc., are widely available through content providers, such as Amazon, iTunes and Netflix. Users can acquire various contents through rental or purchase from these providers. Unfortunately, contents are either separated into individual lockers provided by each content provider and/or a common locker format is used for content such as Ultraviolet. In the former case, users have to go to each content provider and log into each individual locker through their corresponding account in order to access the content. In the latter case, due to the required common format, only those contents that have been stored in the common format can be made available to the users. There is a need to build a digital locker that overcomes these problems. Prior solutions have not adequately been established in the art.

### SUMMARY OF THE INVENTION

This invention is directed to methods and apparatuses for processing content offers for providing digital locker services.

According to an exemplary embodiment, there is provided a method for processing content offers from external sources and from locally hosted sources. The method receives and processes content offers from at least one external source; retrieves content offers from at least one local source; aggregates said processed offer and said retrieved offer.

According to another aspect of an exemplary embodiment, there is provided a digital locker system. The digital locker system comprises an offer processor for processing content offers provided to users through the digital locker system, wherein said content offers comprises content offers from external sources and local sources; and a storage unit for storing said processed content offers.

### BRIEF DESCRIPTION OF THE DRAWINGS

The above features of the present invention will become more apparent by describing in detail exemplary embodiments thereof with reference to the attached drawings in which:

FIG. 1 shows a block diagram of a content offer processor for processing content offer according to the principles of an exemplary embodiment.

FIG. 2 shows a block diagram of a digital locker system which processes the content offers and provides digital locker services to users according to the principles of an exemplary embodiment.

FIG. 3 shows an exemplary flow chart of processing content offers in a digital locker system according to an exemplary embodiment.

FIG. 4 shows an exemplary flow chart of processing user query requests in a digital locker system according to an exemplary embodiment.

FIG. 5 shows an exemplary flow chart of processing user acquisition requests, including purchase and rental requests.

FIG. 6 shows an exemplary flow chart of processing user playback requests.

FIG. 7 illustrates the performed actions when creating a household in a digital locker system according to an exemplary embodiment.

FIG. 8 illustrates the performed actions when updating a household in a digital locker system according to an exemplary embodiment.

FIG. 9 shows an offer personalization process in a digital locker system according to an exemplary embodiment.

FIGS. 10-11 show the play entitlement process when a multimedia application user attempts to play content.

FIG. 12 shows a diagram of a multimedia system according to an exemplary embodiment.

FIG. 13 shows a diagram of a multimedia system according to another exemplary embodiment.

FIG. 14 shows the general framework of a multimedia system according to an exemplary embodiment.

FIG. 15 shows an alternative implementation of a general framework of a multimedia system according to an exemplary embodiment.

### DETAILED DESCRIPTION

A digital locker system which processes the content offer and enables a user obtain content offers from a variety of service providers for content such as video on demand (VOD) content, TV programs and music is disclosed. Such content is organized into a common locker where the system architectures and/or file structures of each of the content providers are different. In the present application, a content offer is an offer that is made to a user to purchase content. A content offer can comprise information such as metadata that describes content, pricing information, access information for obtaining content, a uniform resource locator (URL) describing the location of content, and the like. Content can be video, audio, and the like which a user can consume using a device.

An example of a content offer for purposes of this invention can be a proposal made to a user to buy additional content based on the contents the user has in their digital lockers. For example, a user has bought several science fiction movies from Amazon which are stored in Amazon's digital locker service and the user has also purchased several episodes of science fiction television shows from iTunes which is stored on Apple's servers as a digital locker. The disclosed exemplary systems can analyze the contents of such digital lockers and offer up offers for additional science fiction content which can be purchased from Amazon, iTunes, or any other content provider which can be stored on their corresponding digital locker or other digital locker if supported. Other offers for other types of content (sports, movies, television shows, games, and the like) can be made in accordance with the disclosed exemplary embodiments.

FIG. 1 shows the block diagram of a content offer processor 100 for processing content offers from external sources and from locally hosted sources. The processor 100 comprises an interface 110 used for receiving content offers from external sources, such as Amazon, iTunes and Netflix. The received content offers are processed by a processing unit 120 of the processor 100. A content offer retriever 130 is employed in the processor 100 to retrieve content offers from locally hosted sources. Further, an aggregator 140 aggregates the processed offers from processing unit 120 and the retrieved offers from the retriever 130, and prepare the aggregated offers for further processing.

In one exemplary embodiment, the processing unit 120 processes catalog information based on the received content offers, and the content offers retriever 130 further generates the catalog information for the content from locally hosted sources based on the retrieved content offers. The aggregator 140 also aggregates the catalog information from the processing unit 120 and the retriever 130 to generate the aggregated catalog information for the content from all sources for further processing.

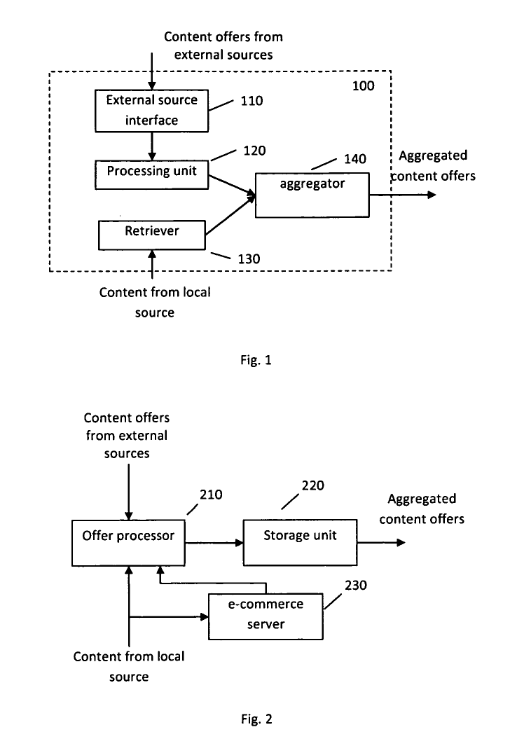

FIG. 2 shows a block diagram of a digital locker system which processes the content offers and provides digital locker services to users according to the principles of an exemplary embodiment. The digital locker system comprises an offer processor 210 and a storage unit 220. The offer processor processes the content offers that are provided to the users through the digital locker system. The content offers comprise content offers from external sources and locally hosted sources. The storage unit stores the processed content offers for use by the users. In one embodiment, the offer processor 100 illustrated in FIG. 1 can be used as the offer processor 210. The digital locker system in FIG. 2 further comprises an e-commerce server 230 for providing entitlement creation for locally hosted content offers.

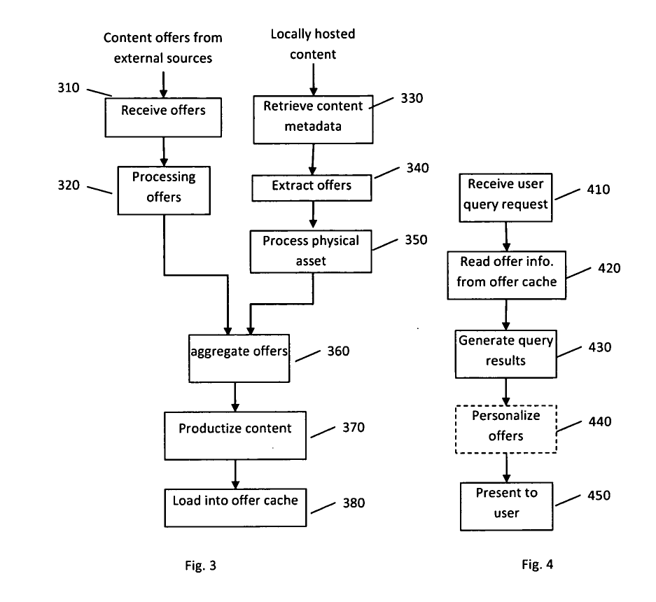

FIG. 3 shows an exemplary flow chart of processing content offers in a digital locker system according to an exemplary embodiment. In step 310, content offers are received from external sources, and are further processed in step 320. In step 330, content metadata is retrieved from locally hosted content. The corresponding content offers are generated in step 340. The digital content contained in the content offer is processed in step 350. Step 360 aggregates the offers processed in step 320 and step 340. The aggregated offers are used to productize the content. The corresponding offers are then loaded into the storage unit in step 380.

The digital locker services provided to the users by the digital locker system comprises content offer query, content acquisition and content playback, which are handled by a service processor of the digital locker system.

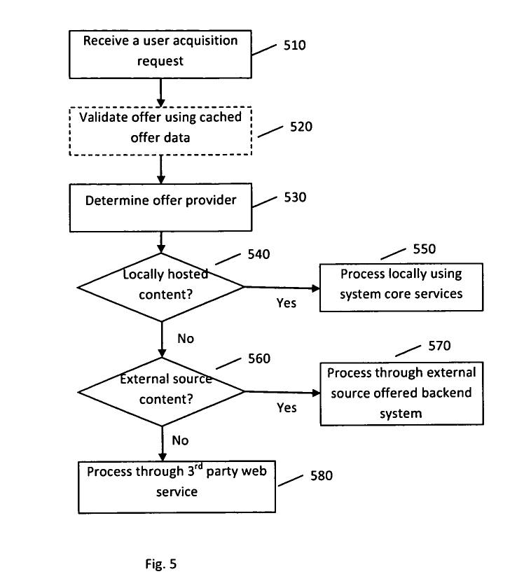

FIG. 4 shows an exemplary flow chart of processing user query requests in the digital locker system. The process starts by receiving a user's query request in step 410. Step 420 reads offer information from the storage unit such as an offer cache which stores the processed and aggregated offers from external content sources and locally hosted content. Query results are generated in step 430. An optional step of 440 personalizes the offers in the generated query results based on, for example, users' preferences. The query results are then presented to the user in step 450.

FIG. 5 shows an exemplary flow chart of processing user acquisition requests, including purchase and rental requests. The process receives a user's acquisition request in step 510. To process the request, an optional step is performed to validate the offer using the stored offer data in step 520. The content offer provider is determined for the requested content in step 530. A determination step 540 is performed to determine if the content provider is locally hosted or not. If yes, acquisition request is processed locally using the system core service in step 550; if not, the process proceeds to step 560, where a determination is made as to whether the content provider is from an external source. If yes, then the acquisition request is processed through external backend system in step 570; if not, which means the content provider is from a third party provider, then the request is processed via third party web services in step 580.

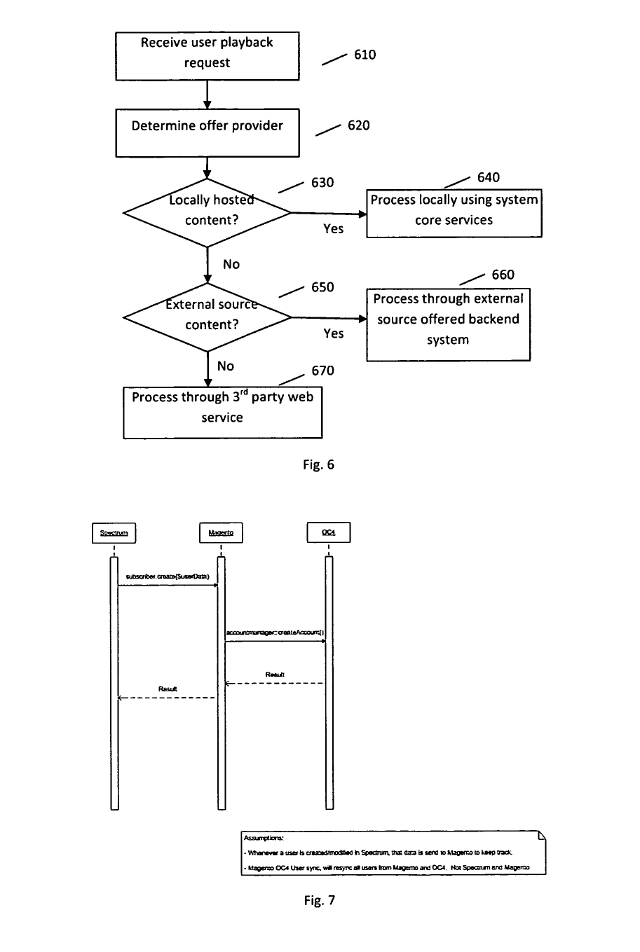

FIG. 6 shows an exemplary flow chart of processing user playback requests. A user playback request for content is received in step 610. The offer provider of the content is determined in step 620. If it is determined in step 630 that the content is a locally hosted content, the system core services are called to process the playback request in step 640; otherwise, the process proceed to step 650, wherein it is further determined whether the content is from an external source. If yes, step 660 processes the user request by calling the external source offered backend system. In a different embodiment, step 660 may check the entitlement of the content offer and obtain a fulfillment URL for the user. If it is determined that the content offer is from a third party, the corresponding processing method, such as through third party web service, is used to process the user playback request.

In the following a detailed embodiment of the digital locker system according to the principles of the present invention, called Navi system, is presented. The external sources for the content include network service providers (NSP). The local host of content would be the Navi system.

The described library is capable of storing relevant metadata and descriptions for content that is purchased/rented from various content providers, such as Navi VOD system (locally hosted content), Amazon, Netflix, iTunes etc. That is, using the architecture presented, the Navi storage locker will have a modular unit that is configured to interface with each content provider. The external calls will be modified to comport with the various content provider. The internal calls will be unified so that the content from the different providers can be unified into a common listing/description.

The Navi system can be implemented using features such as subscriber management, digital locker functionality, entitlement checks, and content fulfillment URL generation using commercial products such as Cisco SiteManager, OpenCase and the like.

When integrating Navi system with SiteManager system, the following may be performed: (1) creation of SiteManager subscribers when Navi households are created. SiteManager subscribers are propagated to OpenCase system and OpenCase users are created. Navi households and subscriber management will be explained later; (2) obtain offer price using SiteManager webservice when content from external sources is acquired and verify that price in acquire REST service call matches SiteManager offer price. REST services are a way to communicate between different modules of the system or across systems; (3) call SiteManager purchase webservice with subscriber ID (Navi household ID) and SKU. SiteManager purchase will propagate to OpenCase system which can then be used for entitlement checks.

When integrating Navi system with OpenCase, the following may be performed: call OpenCase entitlement check service for external source content play requests; and call OpenCase service to obtain content fulfillment URL for NSP content.

### Subscriber/Household Management

The subscribers in the Navi system are organized as households. Each household has a household account, which may contain multiple users. Each user in a household account has a user profile indicating user preferences on the content, access information to content, etc. The household account has the right to assign access to certain content for each user under the household account.

The Navi system provides B2B web services for household management. Creating a household performs the following actions as shown in FIG. 7: creates a Navi household; creates Navi household default user and guest user; creates a SiteManager subscriber using SiteManager client createSubscriber web service and SiteManager system creates an OpenCase user account using SiteManager subscriber information. Note that a Navi household corresponds to a SiteManager subscriber which corresponds to an OpenCase user.

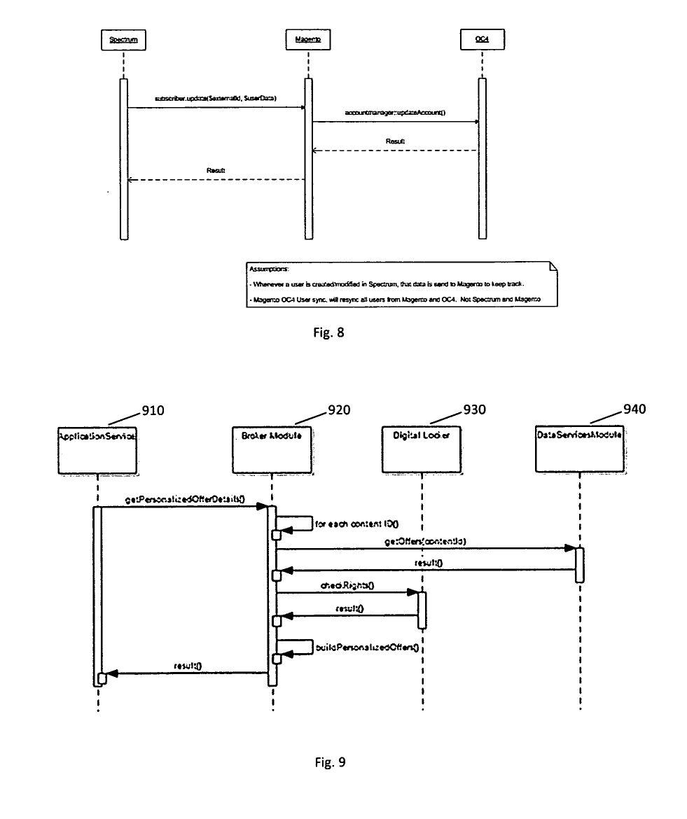

Updating a household performs the following actions as shown in FIG. 8: update Navi household; update SiteManager subscriber using SiteManager client update Subscriber web service; siteManager system updates an OpenCase user account using SiteManager subscriber information.

### Offer Management/Content Acquisition/Content Viewing

The Navi system builds an offer XML file which is an aggregation of offer metadata from SiteManager exported offers and SetJam offers. This offer XML file is loaded into an in-memory cache by the Navi application.

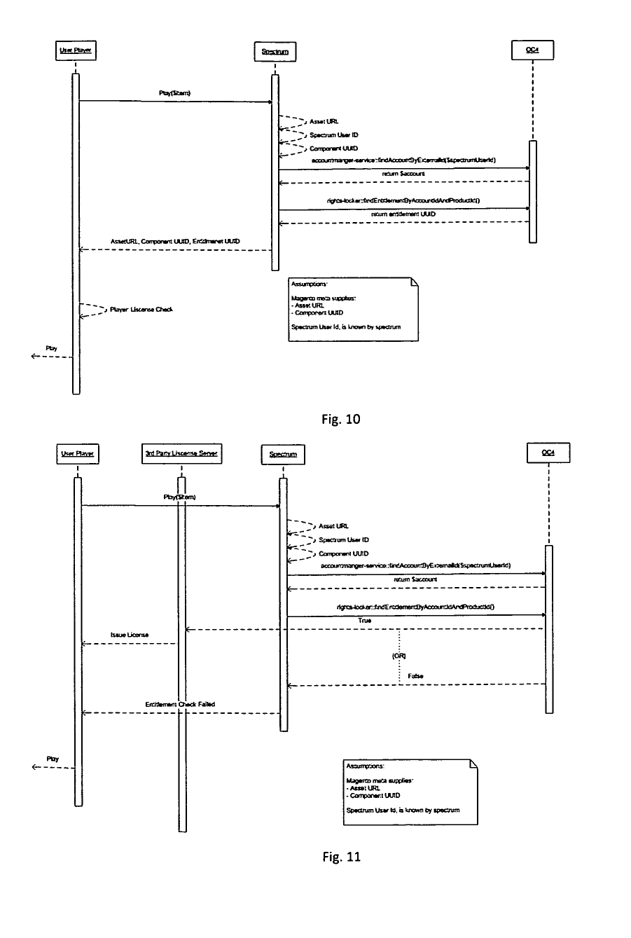

FIG. 9 shows an offer personalization process when a Navi application user navigates down to the content details. An application service 910 sends request to a broker module 920 to get personalized offer details. For each of the requested content offers, which has a unique ID associated, the broker module 920 would send a request to a data service module 940 to get the offer. The data service module 940 performs the search based on the content ID and returns the results to the broker module 920. The broker module 920 sends requests to a digital locker module 930 to check the right of the resulted content offers. Based on the results that are sent from the digital locker module 930, the broker module 920 builds personalized offers and return them to the application service 910 to present to the user.

When a content offer is selected for purchase or rental in the Navi application, the following actions occur: Navi acquire service is called by Navi application; and ContentID and offerID are validated using cached offer data. A ContentID is an identifier that is assigned to content itself. An offerID is an identifier that is assigned to a particular offer which may or may not be dependent on content itself. Further, acquisition is added to Navi Digital Locker module data store.

When content is selected for playback, Navi application uses URL specified in offer metadata purchaseURI to initiate content playback. In one implementation, the purchaseURIs contain either Highwinds CDN unprotected content streaming URLs or unprotected IVA trailer URLs hosted on videodetective.com domain.

In a different embodiment, the Navi system may build an offer XML file which is an aggregation of offer metadata from SiteManager exported offers and SetJam offers. If offer caches are NSP specific, additional NSP configuration parameters will be used to determine which 3^{rd} party offers are included in offer cache. Some examples of the NSP parameters are include/exclude Amazon offers and include/exclude Netflix offers. Based on product requirements, one implementation may include additional business rules such as excluding 3^{rd} party offers for a specified time window for new content offered by the NSP. The offer XML file will be loaded into an in-memory cache by the Navi application.

Offer personalization may include calling either Navi digital locker services or OpenCase digital locker services to obtain purchased and rented content which will be used to filter the offers to the Navi user.

When an offer is selected for purchase or rental in the Navi application, Navi acquire service is called by Navi application. ContentID and offerID are validated using cached offer data. For NSP offers, price information is validated with current SiteManager offer. NSP is obtained using mapping from device/user information in token (Device/User→Household→NSP). Appropriate SiteManager instance purchase webservice is called to add purchase to SiteManager. SiteManager purchase is synchronized with OpenCase system for future entitlement checks. NSP backend system purchase service is called (Note that this may be implemented by using C3 software to tune to specific NSP channel for content acquisition). Purchase is added to Navi Digital Locker module data store. For 3^{rd} party content, purchase flow may be implemented by displaying the offer metadata purchase URL to the user and allowing the user to complete the purchase. Other options include the Navi system calling a 3^{rd} party webservice to complete the purchase process if user account information is available. Purchase may be added to Navi Digital Locker module data store or a 3^{rd} party digital locker data store.

When content is selected for playout, Navi application calls Navi authorize Content or play service with contented. Navi service determines the offer provider (NSP or 3^{rd} party). For NSP content, Navi service calls OpenCase for entitlement check. Navi service calls OpenCase to obtain fulfillment URL for entitled content. Navi service determines CDN provider from fulfillment URL. Navi service adds additional URL parameters based on CDN requirements. For example, Prisma Highwinds CDN fulfillment URL contains multiple query parameters: 1) Token query parameter is an encrypted token with contentId, merchantId, policyId, TTL, 2) Security query parameter is a hash of the fulfillment URL using a preshared security key provided by Highwinds. FIGS. 10-11 show the play entitlement process when a Navi application user attempts to play content.

### Architecture Consideration

External System Settings Mapping

The integration of multiple 3^{rd} party systems with Prisma will require the use of additional external system settings such as IDs. These settings should be mapped to the appropriate Navi domain entity.

The current Navi DB table structure maps some of the external system settings in various tables. For example, SB_HOUSEHOLD table contains NSP_SUBSCRIBER_ID column; SB_EXTERNAL_IDENTITY table maps Navi users to external IDs (Facebook, Twitter, Neptuny, Jinni, etc).

A different implementation may include the following external system settings mappings: Navi NSP to SiteManager webservice endpoint mapping (Each NSP will access a separate SiteManager instance), Navi NSP to SiteManager NSP ID mapping (SiteManager createSubscriber API requires SiteManager NSPID), Navi NSP to OpenCase affiliate ID mapping (OpenCase findAccountByExternalId requires OpenCase affiliate ID).

The system setting mapping will require additional design to ensure a consistent approach and implementation for Navi entity to 3^{rd} party system settings.

In one implementation of the Navi system, contents are classified as NSP hosted content and Navi hosted content, although third party content is also possible. VOD is used as an example of the content. For each type/source of content, the processing of offers is different. For NSP hosted VOD, VOD offers are processed and available in Navi offer cache. VOD offers, content metadata, and physical files are not ingested into OpenCASE. VOD acquisition occurs via STB and NSP back office systems. Video playout occurs via STB and NSP video systems. For Navi hosted VOD (Navi OTT), VOD offers, content metadata and physical files are ingested into OpenCASE. Product bundle, metadata, and offers created in OpenCASE. Physical files are encrypted with PlayReady DRM and uploaded to CDN. Offers are propagated to Magento. Offers are made available in Navi offer cache. Acquisition occurs via Navi core services. Acquisition is persisted in Navi digital locker. Acquisition is persisted in SiteManager (purchase) and OpenCASE (entitlement). Video playout occurs using custom Silverlight player integrated with OpenCASE server and PlayReady license server for license acquisition.

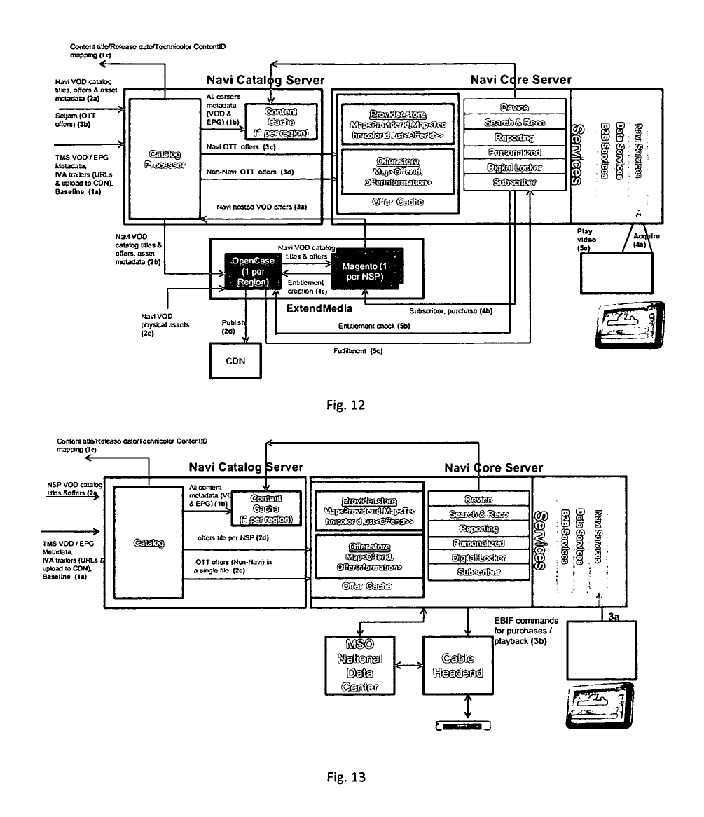

FIG. 12 shows a diagram of the Navi system according to one implementation of an exemplary embodiment. The system comprises a Navi catalog server for processing offers including catalog information and a Navi core server for providing services to users such as processing user's requests. For Navi hosted VOD (Navi OTT), the system works as follows:
1. TMS content metadata is ingested into Navi Catalog and Content Cache.

a) TMS content metadata and Electronic program guide (EPG) data are mapped to Technicolor IDs.

b) Catalog content metadata and EPG data are loaded into content cache;

c) Content title/release date/Technicolor IDs mapping file produced and available for use by NSP.
2. Navi VOD offer is ingested into Navi Catalog

a) Navi VOD offers containing Technicolor content IDs are processed by catalog.

For Navi Hosted VOD or NSP Hosted VOD, table 1 shows an example incoming file to Catalog (provided by NSP) (File naming convention: <NSPId>_offers_<yyyymmdd_hhmmss>.xml. Note that yyyymmdd hhmmss is in UTC 24 hour format.):

TABLE 1

| [symbol] | XML [symbol] Element(s) | Description | Source | Required |
|---|---|---|---|---|
| offerId | < [symbol] Id> | Offer ID. Must be unique within NSP offers | External NSP | Yes |
| | | | offer ID | |
| offerName | < [symbol] name> | Offer name | NSP offer name | Yes |
| offerType | < [symbol] type> | Offer type [symbol] Technicolor specific [symbol] value [symbol] | NSP offer data | Yes |
| offerStartDate | < [symbol] startDate> | Format [symbol] | NSP offer data | Yes |
| | | UTC Time [symbol] yyyy [symbol] mm [symbol] dd [symbol] | | |
| | | UTC Time w/ [symbol] yyyy [symbol] mm [symbol] dd [symbol] | | |
| offerEndDate | < [symbol] endDate> | Format [symbol] | NSP offer data | Yes |
| | | UTC Time [symbol] yyyy [symbol] mm [symbol] dd [symbol] | | |
| | | UTC Time w/ [symbol] yyyy [symbol] mm [symbol] dd [symbol] | | |
| offerPrice | < [symbol] price> | Format decimal value without symols [symbol] at most [symbol] | NSP offer data | Yes |
| | | digits beyond decimal point [symbol] | | |
| currency | < [symbol] currency> | Offer currency [symbol] Technicolor specific [symbol] value [symbol] | NSP offer data | Yes |
| acquisition Url | < [symbol] acquisitionUrl> | Acquisition URL mandatory only for NSP | NSP offer data | Yes |
| | | hosted video | | [symbol] NSP |
| | | | | hosted VOD |
| | | | | only [symbol] |
| sourceContent Id | < [symbol] sourceContentId> | Content Owner′s content Id | NSP offer data | No |
| technicolorId | < [symbol] technicolorId> | Technicolor content ID. | | Yes |
| [symbol] | < [symbol] > | [symbol] name | OpenCASE | Yes |
| | | | [symbol] name | [symbol] Navi |
| | | | | hosted VOD |
| | | | | only [symbol] |
| provider Icon | < [symbol] providerIcon> | Offer specific NSP icon [symbol] If not provided [symbol] | NSP offer data | No |
| | | default icon for NSP is used [symbol] | | |
| policy [symbol] | < [symbol] policyId> | Policy ID | OpenCASE | Yes |
| | | | policy ID | [symbol] Navi |
| | | | | hosted VOD |
| | | | | only [symbol] |

[symbol]

indicates data missing or illegible when filed

b) Catalog deposits content bundle, content metadata, offer into OpenCase workflow hot folder. Below shows an example bundle metadata file from Catalog to OpenCase for Navi Hosted VOD:

File naming convention: <TechnicolorID>_bundle_metadata_<contentTitle>.xml

File location: incoming folder for new files, updated folder for modified files.

TABLE 2

| [symbol] | XML [symbol] Element(s) | Description | Source | Required | Data Category |
|---|---|---|---|---|---|
| Name | < [symbol] name> | VOD content title | [symbol] content title | Yes | Bundle |
| altCode | < [symbol] altCode> | Navi content Technicolor ID | Technicolor ID | Yes | Bundle |
| External ID | < [symbol] externalID> | Content owner′s content ID | NSP provided | No | Bundle |
| isActive | < [symbol] isActive> | Bundle status [symbol] active or inactive [symbol] | Set by Navi catalog Set to inactive | No | Bundle |
| | | | if the content is deleted | | |

[symbol]

indicates data missing or illegible when filed

Table 3 shows an example content metadata files from Catalog to OpenCase for Navi hosted VOD.

File naming convention: <TechnicolorID>_metadata_<contentTitle>_locale.xml

File location: incoming folder for new files, updated folder for modified files

TABLE 3

| [symbol] | XML [symbol] Element(s) | Description | Source | Required | Data Category |
|---|---|---|---|---|---|
| Name | < [symbol] name> | [symbol] title | Generated by catalog. Info includes [symbol] | Yes | Content metadata |
| altCode | < [symbol] altCode> | Technicolor ID | Technicolor ID | Yes | Content metadata |
| [symbol] | < [symbol] > | [symbol] | User Input | Yes | Content metadata |
| | < [symbol] country> | Includes country and language | | | |
| | < [symbol] language> | | | | |
| Long title | < [symbol] titleLong> | VOD content title | TMS content title | Yes | Content metadata |
| Release [symbol] | < [symbol] release [symbol] > | Release [symbol] | TMS content release [symbol] | Yes | Content metadata |
| Genre(s) | < [symbol] genres> | Genre | TMS content genre | | Content metadata |
| | < [symbol] genre> | Multiple genres supported | | | |
| | < [symbol] genreName> | | | | |
| Rating | < [symbol] ratings> | Rating | TMS rating | No | Content metadata |
| | < [symbol] rating> | Rating name and optional rating [symbol] | | | |
| | < [symbol] rating [symbol] > | supported | | | |
| | < [symbol] ratingName> | | | | |
| Publisher | < [symbol] publisher> | Content publisher | TMS content publisher or owner | No | Content metadata |
| Directors | < [symbol] directors> | Directors | Content directors | No | Content metadata |
| | < [symbol] director> | | | | |
| castMembers | < [symbol] castMembers> | Cast members Limited to [symbol] cast | TMS actors | No | Content metadata |
| | < [symbol] castMember> | members | | | |

[symbol]

indicates data missing or illegible when filed

Table 4 shows an example offer files from Catalog to OpenCase for Navi hosted VOD.

File naming convention: <TechnicolorID>_offer_<offerId>.xml

Note: offerId is generated by Catalog and must be unique across all OpenCASE offers <NSPCallSign<>external_offerid>

Note: NSPCallSign is a 3 letter NSP specific code

File location: incoming folder for new files, updated folder for modified files

TABLE 4

| Offer [symbol] | XML File Element(s) | Description | Source | Required |
|---|---|---|---|---|
| name | <tns:name> | Offer name | External NSP offer name | Yes |
| assetId | <tns:assetId> | Asset name as [symbol] into OpenCase | OpenCASE asset file name | Yes |
| currency | <tns:currency> | Currency | NSP offer currency. Mapped to | Yes |
| | | | OpenCASE currency value | |
| offerEndDate | <tns:offerEndDate> | Format: | NSP offer end date | Yes |
| | | UTC Time: yyyy-mm-ddThh: [symbol] | | |
| | | UTC Time w/offset: yyyy-mm-ddThh: [symbol] | | |
| offerId | <tns:offerId> | Offer ID | Technicolor Offer ID | Yes |
| offerType | <tns:offerType> | Offer type [symbol] purchase [symbol] rental [symbol] | NSP offer type. Mapped to OpenCASE | Yes |
| | | | offer type value | |
| offerStartDate | <tns:offerStartDate> | Format: | NSP offer start date | Yes |
| | | UTC Time: yyyy-mm-ddThh: [symbol] | | |
| | | UTC Time w/offset: yyyy-mm-ddThh: [symbol] | | |
| policyUUID | <tns:policyUuid> | Policy ID | OpenCASE policy UUID | Yes |
| Price | <tns:price> | Format is decimal value without symbols | NSP price | Yes |

[symbol]

indicates data missing or illegible when filed

c) Physical asset is ingested into OpenCase

d) Encrypted asset is published to CDN
3. Content is productized and offer information flows to SiteManager/Magento

a) Magento exports all VOD offer information to Catalog.

Table 5 shows an example offer files exported from SiteManager/Magento to Catalog offer processor for Navi Hosted VOD.

File naming convention: magento2catalog_<providerName>_<providerID>.csv

File location: SiteManager export folder (/var/www/html/var/export)

Note: Export folder is configurable in SiteManager export profile

TABLE 5

| JSON Offer Attribute Name | Site Manager Attribute Value |
|---|---|
| [symbol] | [symbol] or [symbol] _offer_ [symbol] Note: Both |
| | field values should be the same |
| externalId | [symbol] _offer_ [symbol] .substring(4, [symbol] ) |
| startDate | [symbol] _offer_start_date |
| endDate | [symbol] _offer_end_date |
| name | name |
| type | [symbol] _offer_type |
| icon | Offer provider icon URL not |
| | available in SiteManager. |
| | Should use provider ID [symbol] Provider |
| | icon URL mapping in catalog |
| price | price |
| currency | [symbol] _currency |
| providerId | Use <providerID> from export file name |
| providerName | Use <providerName> from export file name |
| technicolorId | [symbol] _technicolor_ [symbol] |

[symbol]

indicates data missing or illegible when filed

b) Catalog processes setjam offers, associates technicolor content id to each of the offer

Table 6 shows an example offer file that is processed in the Catalog for Navi hosted VOD.

File naming convention: programs.xml

File location: pull into catalog processor hot folder

TABLE 6

| JSON Offer Attribute Name | SetJam Offer File Element/Attribute |
|---|---|
| [symbol] | [symbol] |
| exernalId | setJamId |
| startDate | Currently not provided by setJam, |
| | default to empty string |
| endDate | Currently not provided by setJam, |
| | default to empty string |
| name | title |
| type | links/link/type |
| icon | Offer provider icon URL not available |
| | in SiteManager |
| acquistionUrl | links/link/url |
| Price | links/link/price |
| currency | [symbol] of links/link/price is maped to currency code |
| providerId | Use links/link/source value and map |
| | to provider ID |
| providerName | links/link/source |

[symbol]

indicates data missing or illegible when filed

c) Catalog generates a single offer file for current Navi OTT offers form (3a). These offers are loaded into offer cache. Current=startDate<current date+1 day and endDate>current date

d) Catalog generates a single offer file for all current non-navi OTT offers from (3b) and these are loaded into offer cache. Current=startDate<current date+1 day and endDate>current date
For Navi OTT VOD and non_Navi OTT offers that are sent from Catalog to Navi offer cache, the location to drop files into is Navi Core server offer cache hot folder.
Non-Navi OTT offers: file naming convention: ott_offer_metadata_yyyymmdd_hhmmss.xml
Navi OTT offers:file naming convention: navi_ott_offer_{—metadata}_yyyymmdd_hhmmss.xml
Below shows an example offer cache XML file with JSON Data:

```
<?xm l version=“1.0” encoding=“U TF-8”?>
<contents>
        <content>
              <id>1MVfc422a99f8131887b6149655cdce8696</id>
              <offers>
                      <offer>
                            <|[CDATA [{
                                    “id”:“b8372af6-e7d3-47cf-a844-3c5687ba4592”,
                                    “startDate”:1299880129582,
                                    “endDate”:1332538581824,
                                    “name”:“VO D Offer”,
                                    “type”:“RENTA L”,
                                    “icon”:“http://hwcdn.net/d5h8c4n6/cds/vodrent.jpg”,
                                    “acquisitionUrl”:“http://hwcdn.net/d5h8c4n6/fms/1_Tesco_PP
                            C_MerryM adagascar_512×288_2398_ST_Preview,flv”,
                                    “price”:1.99,
                                    “currency”:“USD”,
                                    “providerId”:00000000,
                                    “providerName”: Navi”
                                    }]]>
                      </offer>
                      ...
              </offers>
        </content>
        ...
<contents>
```

Below shows an example Navi offer cache XML schema (XSD):

```
<?xml version=“1.0” encoding=“U TF-8”?>
<!-- Offer catalog -->
<!-- File: offers.xsd -->
<!--Copyright Technicolor 2011. All rights reserved. -->
<xs:schema xmlns:xs=“http://www.w3.org/2001/XMLSchema”
elementForm Default=“qualified”
attributeForm Default=“unqualified” version=“2.0”>
        <xs:element name=“contents”>
              <xs:annotation>
              <xs:documentation>Root element for the
              offers.</xs:documentation>
              </xs:annotation>
              <xs:complexType>
                      <xs:sequence>
                          <xs:element ref=“content” minOccurs=“1”
                          maxOccurs=“unbounded”/>
                      </xs:sequence>
              </xs:complexType>
        </xs:element>
        <xs:element name=“content”>
              <xs:complexType>
                      <xs:sequence>
                          <xs:element ref=“offers” minOccurs=“1”/>
                      </xs:sequence>
              </xs:complexType>
        </xs:element>
        <xs:element name=“offers”>
              <xs:complexType>
                      <xs:sequence>
                      <xs:element name=“offer”
              type=“xs:string” minOccurs=“1”
              maxOccurs=“unbounded. />
                      </xs:sequence>
              </xs:complexType>
        </xs:element>
</xs:schema>
```

Below shows an example Navi content title/release date/Technicolor ID mapping file. This mapping file will be provided to the NSP to enable the NSP to provide NSP offer files containing Technicolor Content IDs.

```
<?xml version=“1.0” encoding=“U TF-8”?>
<!-- contentid to title m apping -->
<!-- File: technicolor_contentid_m ap_yyyym m dd.xm l -->
<!--Copyright 2011 Technicolor. All rights reserved. -->
<titlemap xmlns:xsi=“http://www.w3.org/2001/XML.Schema-instance”
              “xsi:noNamespaceSchemaLocation=
        technicolor_contentidmap.xsd”schemaVersion=“2.0”>
        <content_item contentID=“<technicolor_content_id>”>
              <title value=“content_title” date=“title_release_year”>
              <title value=“content_title” date=“title_release_year”>
              <title value=“content_title” date=“title_release_year”>
              <title value=“content_title” date=“title_release_year”>
              ...
        </content_item>
</titlemap>
```

4. User purchases Navi VOD content

a) Request is sent to the Navi Core Server via web service and acquisition is persisted in Navi Digital Locker;

b) Navi Core Server invokes purchase call in Magento for Navi household (Magento subscriber) for Navi OTT content;

c) Magento creates entitlement in OpenCASE for Navi household (OpenCASE user) for Navi OTT content.
5. User plays Navi VOD content

a) Request is sent to Navi Core Server via web service for entitlement data;

b) Navi Core Server calls OpenCASE entitlement check service;

c) Entitlement credentials and fulfillment URL is returned to the Navi application for playback.

FIG. 13 shows a diagram of the Navi system according to one implementation of an exemplary embodiment with the data flow for NSP hosted VOD:
1. TMS content metadata is ingested into Navi Catalog and Content Cache

a) TMS content metadata and EPG data are mapped to Technicolor IDs;

b) Catalog content metadata and EPG data are loaded into content cache;

c) Content title/release date/Technicolor IDs mapping file is produced and available for use by NSP.
2. NSP VOD catalog maps to Navi content Technicolor ID

a) NSP VOD offers containing Technicolor content IDs are processed by catalog;

b) Catalog processes Setjam offers and associates each offer with technicolor content Id;

c) Catalog generated single offer file for current non-Navi OTT offers (setjam) is loaded into the offer cache. For NSP hosted offers, the file naming convention is NSP<NSPID>_offer_metadata_yyyym m dd_hhm m ss.xml. Below shows an example offer cache XML file with JSON data.

```
<?xm l version=“1.0” encoding=“U TF-8”?>
<contents>
        <content>
              <id>1MVfc422a99f8131887b6149655cdce8696</id>
              <offers>
                      <offer>
                            <#[CDATA [{
                                    “id”:“b8372af6-e7d3-47cf-a844-3c5687ba4592”,
                                    “startDate”:1299880129582,
                                    “endDate”:1332538581824,
                                    “name”:“VOD Offer”,
                                    “type”:“RENTA L”,
                                    “icon”:“http://hwcdn.net/d5h8c4n6/cds/vodrent.jpg”,
                                    “acquisitionUrl”:“http://hwcdn.net/d5h8c4n6/fms/1_Tesco_PP
                            C_MerryMadagascar_512×288_2398_ST_Preview.flv”,
                                    “price”:1.99,
                                    “currency”:“USD ”,
                                    “providerId”:999999999,
                                    “providerName”:“Charter”
                                    }]]>
                      </offer>
                      ...
              </offers>
        </content>
        ...
<contents>
```

d) Catalog generates one file per NSP offers and these are loaded into the offer cache.
3. User purchases VOD content

a) Request is sent to the Navi Core Server via web service with EBIF command;

b) Navi Core Server sends EBIF com m and to STB for VOD purchase or playback.

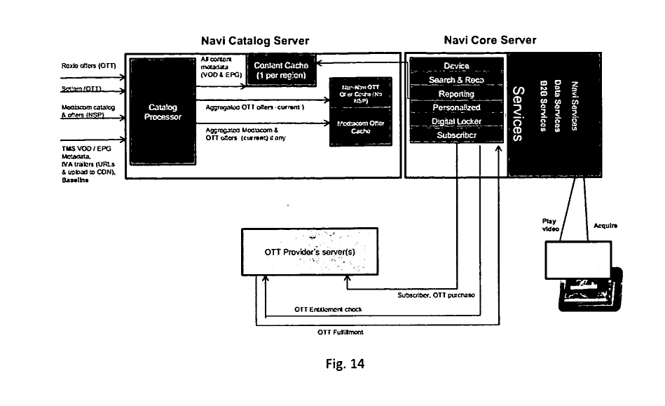

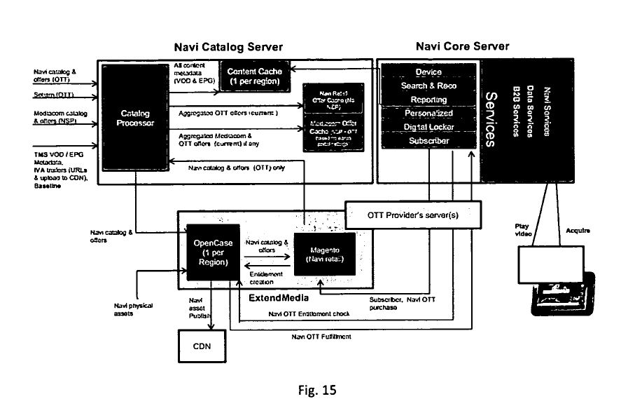

FIGS. 14 and 15 show the general framework of the Navi system according to different embodiments of the current invention.

It is to be understood that the disclosed exemplary embodiments may be implemented in various forms of hardware, software, firmware, special purpose processors, or a combination thereof. The disclosed exemplary embodiments can be implemented as a combination of hardware and software. Moreover, the software can be implemented as an application program tangibly embodied on a program storage device. The application program may be uploaded to, and executed by, a machine comprising any suitable architecture. The machine can be implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof), which is executed via the operating system. In addition, various other peripheral devices may be connected to the computer platform such as an additional data storage device and a printing device.

Although the exemplary embodiments have been described in detail herein, it is to be understood that this invention is not limited to these embodiments, and that other modifications and variations may be effected by one skilled in the art without departing from the scope of the invention as defined by the appended claims.

1. A method for processing content offers from external sources and from local sources, comprising:
receiving and processing content offers from at least one external source;
retrieving content offers from at least one local source; and
aggregating said processed offers and said retrieved offers.

2. The method of claim 1, wherein said content offers comprise access information of corresponding content contained in said content offers.

3. The method of claim 1, wherein said processing content offers comprises processing catalog information based on said received content offers.

4. The method of claim 1, wherein said retrieving content offers comprises generating catalog information based on said retrieved content offers.

5. The method of claim 1, wherein said aggregating is performed based on a rule.

6. A content offer processor, comprising:
an interface for receiving content offers from at least one external source;
a processing unit for processing said received content offers;
a content offer retriever for retrieving content offers from at least one local source; and
an aggregator for aggregating said processed offers from said processing unit and said retrieved offers from said content offer retriever.

7. The content offer processor of claim 6, wherein said content offers comprise access information of corresponding content contained in said content offers.

8. The content offer processor of claim 6, wherein said processing unit processes catalog information based on said received content offers.

9. The content offer processor of claim 6, wherein said content offer retriever generates catalog information based on said retrieved content offers.

10. The content offer processor of claim 6, wherein said aggregator performs aggregating based on a rule.

11. A method for providing digital locker services, comprising:
processing content offers provided to users through said digital locker services, wherein said content offers comprise content offers from at least one external source and at least one local source; and
storing said processed content offers for use by said users.

12. The method of claim 11, further comprising:
productizing content contained in said processed offers.

13. The method of claim 12, wherein said productizing step comprises
creating entitlement information for content contained in said processed offers from said at least one local source.

14. The method of claim 11, further comprising:
processing requests from said users.

15. A digital locker system, comprising:
an offer processor for processing content offers provided to users through the digital locker system, wherein said content offers comprises content offers from at least one external source and at least one local source; and
a storage unit for storing said processed content offers.

16. The digital locker system of claim 15, further comprising:
an e-commerce server for creating entitlement information for content contained in said processed offers from said at least one local source.

17. The digital locker system of claim 15, further comprising a service processor for processing a user request.

18. The digital locker system of claim 17, wherein said user request comprises one of a user playback request and a user acquisition request.

19. A method for processing a user request in a digital locker service, comprising:
receiving a user request for a content;
determining a scheme for said content by determining whether said content is locally hosted, wherein if said content is locally hosted, determine said scheme as using local service; otherwise determine said scheme as using external service; and
processing said user request using said determined scheme.

20. The method of claim 19, wherein said user request comprises one of a user playback request and a user acquisition request.
